(19) United States
(12) Patent Application Publication
(10) Pub. No.: US 2013/0104585 A1
(43) Pub. Date: May 2, 2013

(54) PORTABLE COOLING UNIT FOR FIELD-LEVEL COOLING OF PRODUCT

(71) Applicants: Frederic R. Weeth, Pacific Grove, CA (US); Michael J. Azzopardi, Salinas, CA (US)

(72) Inventors: Frederic R. Weeth, Pacific Grove, CA (US); Michael J. Azzopardi, Salinas, CA (US)

(21) Appl. No.: 13/282,250

(22) Filed: Oct. 26, 2011

(51) Int. Cl. A23L 3/00

(52) U.S. Cl. 62/268

(57) ABSTRACT

A portable cooling unit is disclosed for vacuum cooling products such as product at a worksite such as a field where the produce is harvested. When cooling product, the portable cooling unit includes a retort, at least one shuttle coupled to the retort and a condensation assembly. The condensation assembly includes primary and secondary refrigerant load subassemblies. Each of these components may be disassembled from each other into modular units which may be easily transported to and from the worksite.

### BACKGROUND OF THE INVENTION

1. Field

The present technology relates to systems and methods for cooling product such as produce.

2. Description of Related Art

Fruits and vegetables are living organisms that continue essential chemical and physiological activities after harvest. These activities can include physiological breakdown, physical injury to tissue, invasion by microorganisms, and moisture loss. Additionally, some fruits and vegetables can suffer damage while being transported hot from the field. Thus, the time between harvest and cooling to remove field heat and slow plant respiration, otherwise known as the “cut-to-cool” interval, is critical for ensuring the quality and safety of the product.

The term “cold chain” refers to the uninterrupted temperature management of perishable product in order to maintain quality and safety from the point of post-harvest cooling through the distribution chain to the final consumer. The cold chain ensures that perishable product are safe and of high quality at the point of consumption. Failing to keep product at the correct temperatures can result in a variety of negative attributes including, among others, textural degradation, discoloring, bruising, and microbial growth.

Typically, fruits and vegetables may be harvested into trucks which carry the produce to fixed-base cooling facilities, where the produce is cooled and the cold chain begins. The produce is then transported from the cooling facilities to their final destination, often in refrigerated semitrailers called reefers. Starting the cold chain at the cooling facility has several drawbacks. For example, during transport from the field to the cooling facility in open vehicles, the produce is generally exposed to wind, sun and heat, which can result in moisture loss, physiological breakdown and textural degradation. A further drawback is the need to have produce grown proximately to cooling facilities to minimize the time between harvest and start of the cold chain.

Once at the cooling facility, produce such as lettuce and other leafy vegetables may be cooled in a vacuum cooling unit. Generally, the produce is transferred into the vacuum cooling unit, and the unit is then sealed and the air is pumped down to near vacuum levels. As the ambient pressure within the unit decreases, it approaches the saturated vapor pressure of the water within the produce, resulting in water vaporization from the surface of the produce. The surface vaporization in turn results in localized cooling of the produce due to the energy requirement of the water vapor phase change. In order to get rid of the vaporized water, vacuum cooling units typically include a condenser assembly for condensing the water vapor to liquid, which takes up a smaller volume and can be removed from the cooling unit.

Vacuum cooling units at a cooling facility are generally referred to as fixed-base units, in that it is a difficult and time consuming process to break down and transport these cooling units. First, the fixed-base cooling units tend to be modular, and do not break down into small sub-units which may be easily transported. Second, ammonia is a preferred circulating refrigerant within the condenser assembly to condense the evaporated water. Ammonia is a highly controlled substance due to its potential dangers if spilled, and Environmental Protection Agency's Risk Management Program (RMP) promulgates several regulations for the use and transport of ammonia. For example, operating and safety permits are required when working with 500 lbs. of ammonia or more (fixed-base cooling units use at least this amount). Second, when transporting this quantity of ammonia, the ammonia must first be pumped down and evacuated from the pipes and condenser circulation system, and a specialized and authorized technician must be present to oversee the break down process. All of this makes it difficult, time-intensive and costly to break down fixed-based cooling units.

### DESCRIPTION OF THE DRAWINGS

FIG. 1 is a top view of a portable cooling unit in operation at a worksite such as a field where produce is harvested.

FIG. 2 is a top view of a portable cooling unit according to embodiments of the present disclosure.

FIG. 3 is a side view of portions of a portable cooling unit according to embodiments of the present disclosure.

FIG. 4 is a side view of portions of a portable cooling unit according to embodiments of the present disclosure disassembled into subassemblies.

FIG. 5 is a schematic representation of the portable cooling unit according to embodiments of the present disclosure.

FIG. 6 is a schematic representation of the portable cooling unit according to an alternative embodiment of the present disclosure.

FIG. 7 is a graph of the draw on the thermal reservoir of FIG. 6 over time.

### DETAILED DESCRIPTION

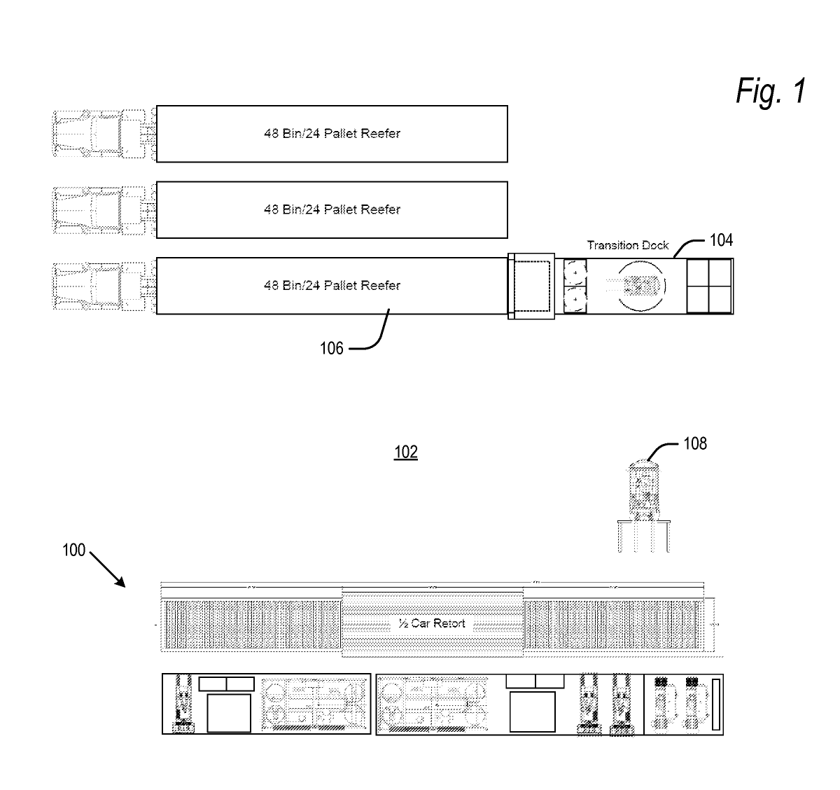

Embodiments of the present disclosure will now be described with reference to FIGS. 1-7, which in general relate to a portable unit for cooling produce or other product. The cooling unit may be easily assembled and disassembled at a worksite such as a field where produce is harvested to allow initiation of the cold chain at the field level. The cooling unit also makes efficient use of primary and secondary refrigerants in a way that minimizes hazard and the triggering of administrative regulations for the use and transport of the primary and secondary refrigerants with the cooling unit.

It is understood that the present invention may be embodied in many different forms and should not be construed as being limited to the embodiments set forth herein. Rather, these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

FIG. 1 shows a portable cooling unit 100 for cooling product such as produce and beginning the cold chain. As described below, the cooling unit 100 may employ a vacuum cooling process effective for cooling vegetables having a high surface area to mass ratio. Such vegetables include but are not limited to iceberg and other kinds of lettuce, spinach, cauliflower, bok choy, bean sprouts, mushrooms, celery, artichokes, green onions, cabbage and other leafy vegetables. It is understood that the cooling unit according to the present disclosure may be used to cool a variety of other product including fruits, meats and other non-produce items.

The cooling unit 100 is shown in FIG. 1 deployed at a worksite 102, which in embodiments may be a field where produce is harvested. In such embodiments, the present technology allows the cold chain to start at the field-level right after the produce is harvested. This is in contrast to conventional systems where the cold chain does not start until product is transported from the field to a fixed-base cooling facility where it is then processed. In other embodiments, it is understood that the worksite 102 may be any location where product is cooled, including for example a traditional fixed-base cooling facility.

In examples, the cooling unit 100 may work in conjunction with a portable transition dock 104, so that items are cooled in the cooling unit 100 as explained below, and then transferred by a field fork lift 108 (or other conveyor) onto the transition dock 104. The transition dock then transfers the cooled product to waiting transport conveyors 106, which in embodiments may be refrigerated semitrailers called reefers. Further details relating to the transition dock 104 are disclosed in co-pending patent application Ser. No. 13/252,875, entitled, “Portable Transition Dock for Palletized Product,” filed Oct. 4, 2011, which application is incorporated herein by reference in its entirety.

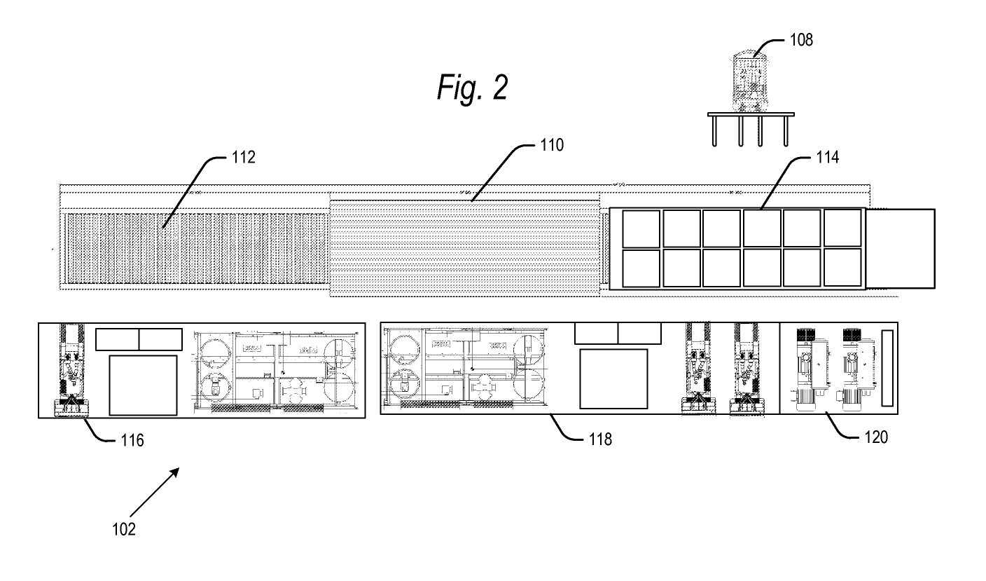

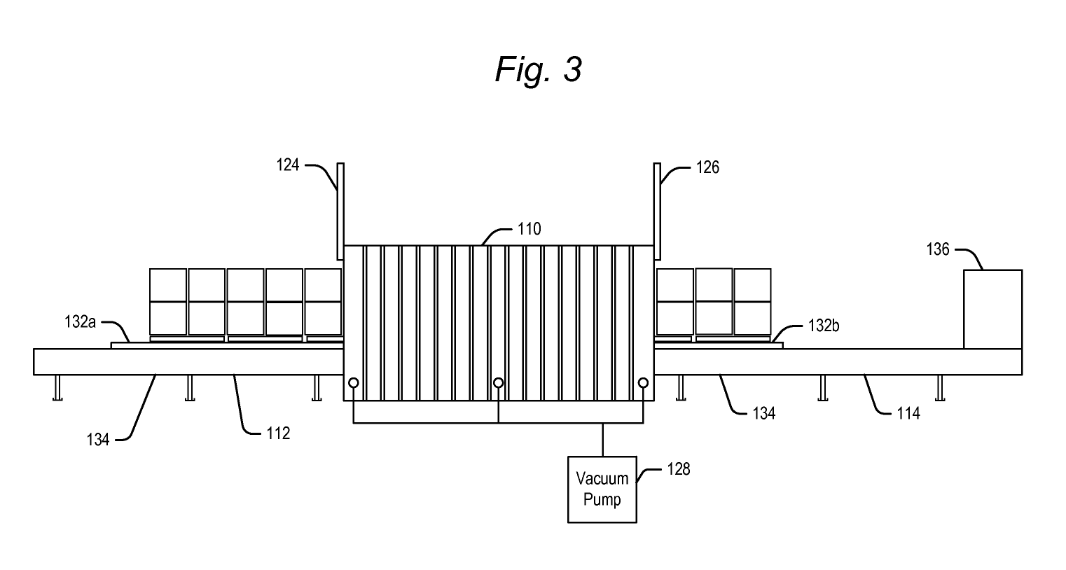

FIGS. 2 and 3 show top and side views, respectively, of the portable cooling unit 100. The cooling unit 100 includes a number of discrete subassemblies, including retort 110, shuttles 112, 114, primary refrigerant load 116, secondary refrigerant load 118 and power generator sets 120. In operation, each of these subassemblies are integrated together to allow vacuum cooling of product. However, when it is desired to transport the portable cooling unit 100, these subassemblies may be easily separated into discrete, modular components and transported separately. Each of these modular subassemblies is explained below.

Retort 110 is an enclosed, sealable chamber where cooling of product is performed. In one example, retort 110 may be cuboid-shaped with four planar walls to define a tube with open ends, and a pair of vertically oriented doors 122, 124 for sealing the open ends. In one example, the retort 110 may have a length of 26 feet, a width of 12 feet and a height of 12 feet. These dimensions are by way of example only, and may vary in further embodiments. The retort may also be other shapes in further embodiments.

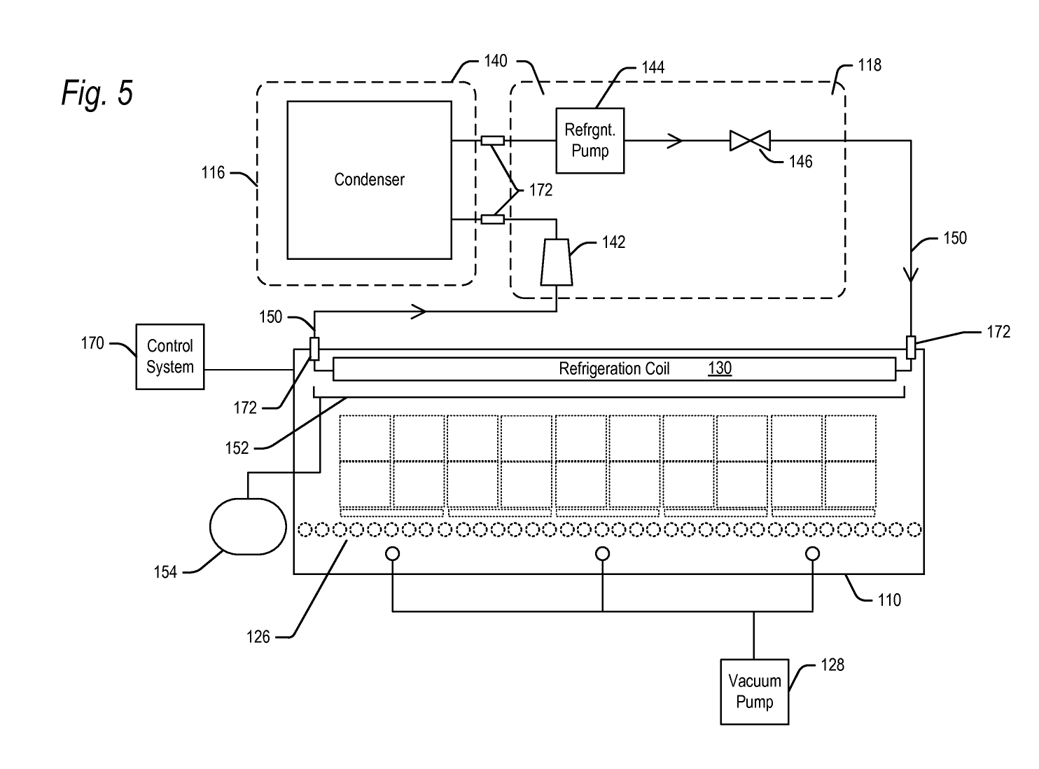

Doors 122, 124 may open to allow entry of product into the interior of the retort 110, and may close to seal the interior of the retort to allow evacuation of the interior of the retort and creation of a vacuum or near vacuum. The doors 122, 124 may be mounted on vertical tracks in the ends of the retort 110, and may be hydraulically actuated under the control of a control system 170 to open and close in sync with each other. The control system 170 is shown schematically in FIG. 5 and explained hereinafter.

The interior of the retort 110 may include a floor having a conveyor 126 (FIG. 5) for supporting shuttle platforms 132 as the platforms move into and out of the retort 110 as explained below. In one example, conveyor 126 may be a number of conveyor rollers together defining a generally planar upper surface for translationally supporting the platforms. A belt may be provided over the conveyor rollers in further embodiments. Other types of conveyors are known. In one further example, the platform itself may be mounted on wheels that ride in a track provided both within the retort 110 and on the shuttle carriages 134 explained below.

A vacuum pump 128 may be provided to evacuate the air from within the retort 110, under the control of the control system 170. As is also shown in FIG. 5, a finned refrigeration coil 130 may be mounted in the ceiling of the retort 110. The refrigeration coil 130 forms part of a condenser assembly 140 (explained below) to condense the water vapor evaporated from the produce upon lowering of the internal pressure by vacuum pump 128.

Shuttles 112 and 114 may be provided on both ends of retort 110, adjacent respective doors 122, 124. Each shuttle may include a planar platform 132 translatably supported on an undercarriage 134, for example on conveyor rollers as inside the retort 110. Each platform 132 has a size that can fit completely within retort 110. When a platform 132 is positioned on its carriage 134, product may be loaded onto and removed from the platform by field forklift or other conveyor 108. Product may be loaded on pallets, and may be in open containers or pre-packaged, as long as the packaging allows for vapor removal.

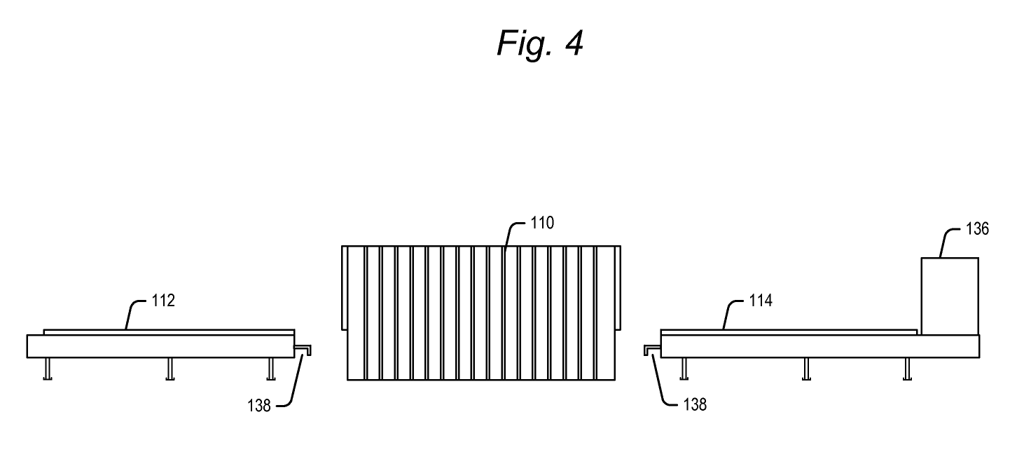

The carriage 134 may releasably couple to the retort 110 to join the shuttles 112, 114 to the retort 110 and to ensure proper alignment of the shuttles to the retort. In one embodiment, there may be pins 138 (FIG. 4) mounted on the shuttles 112, 114, which engage within receiver sockets (not shown) on respective ends of the retort 110. Other coupling mechanisms may be provided.

The carriage 134 may include a hydraulic suspension allowing shuttles to raise and lower to match the height of retort 110. As explained below, the shuttles 112, 114 may be separated from the retort, and loaded on a flatbed of a semitrailer (or on top of the retort) for transport. In further embodiments, the carriage 134 may include an axle and wheels for connecting to a cab of a semitrailer for transporting the shuttles.

The shuttles may further include a drive system 136 for translating the platforms 132 of each shuttle 112, 114 between an external position on its carriage 134 and an internal position within retort 110. The drive system 136 may include a chain or belt coupled to both platforms 132, which chain or belt is rotated by a motor under the control of the control system 170.

A single drive system 136 may be coupled to both platforms 132 on the respective shuttles 112, 114 so that they pivot back and forth in unison with each other. In operation, a first platform 132a may be loaded with product and sealed within the retort 110 with both doors 122, 124 closed to evacuate the chamber and cool the product. During this process, the second platform 132b may be positioned on its carriage 134. The field forklift 108 may load new pallets of product to be cooled onto the second platform 132b, which then awaits for the retort 110 to open. This scenario is shown in FIG. 2.

When cooling of the first product is complete, the control system 170 signals the doors 122, 124 to both open, and signals the drive system 136 to move the first platform 132a out of the retort 110 as the second platform 132b is moved into the retort. This scenario is shown in FIG. 3. Once the second platform is fully within the retort 110, the control system 170 signals to close the doors 122, 124, air is evacuated from the retort chamber, and product on the second platform 132b is cooled. As this is taking place, the cooled product on the first platform 132a is offloaded by forklift 108 and new, warm product is positioned on the first platform 132a. When cooling of the product on the second platform 132b is complete, the second platform 132b moves out of the retort 110 as the first platform 132a moves in and the process repeats.

The above-described drive system 136 and method of operation is by way of example only, and a wide variety of drive systems and methods of operation may be used in further embodiments. In one further example, each platform 132 may be translated into and out of the retort 110 by separate drive systems. In such an example, the respective shuttles may be moved into and out of the retort in unison as described above. Alternatively, where connected to separate drive systems, the platforms 132a, 132b may move independently of each other so that when one platform moves out of the retort 110, the other platform does not necessarily move in.

Having shuttles 112, 114 on both ends of the retort 110 allows product to be transferred from/to one shuttle while product is cooled on the other shuttle within the retort. However, in further embodiments, it is understood that the present technology may operate with a single shuttle. In this embodiment, product is loaded onto the single shuttle, cooled within the retort 110, and then offloaded and the process repeats. In such an embodiment, the retort 110 may include a single door instead of two.

The primary and secondary refrigerant load subassemblies 116, 118 will now be described in greater detail with respect to FIGS. 5-7. The subassemblies 116, 118 in general together form a condenser assembly 140 for condensing water vapor that evaporates off of the product being cooled within retort 110. Prior fixed-base cooling stations included a single cooling assembly using for example a large quantity of ammonia as the circulating refrigerant. However, the present technology uses a primary refrigerant circulating in the primary refrigerant load subassembly 116 and a secondary refrigerant circulating in the secondary refrigerant load subassembly 118. The primary refrigerant cools the secondary refrigerant, which in turn circulates through the refrigeration coil 130 to cool and condense the water vapor within retort 110. Examples of these subassemblies are explained in greater detail below.

FIG. 5 schematically shows components of a single stage refrigeration cycle which may be included in the secondary refrigerant load subassembly 118 for circulating a secondary refrigerant to cool and condense water vapor within the retort 110. A wide variety of refrigeration cycles and associated components are known, and may be used in different examples of the secondary refrigerant load subassembly 118. In one example, the secondary refrigerant load subassembly 118 includes a compressor 142, a refrigerant pump 144 and an expansion throttle 146. A refrigerant, referred to herein as the secondary refrigerant, may circulate through these components through lines 150. Lines 150 may also carry the secondary refrigerant to primary refrigerant load subassembly 116 for cooling as explained below.

In embodiments, the secondary refrigerant may for example be glycol and in embodiments a solution of about 25%-30% glycol in water. One advantage to the use of glycol is that it does not require operating and safety permits for its use or transport. Other known refrigerants may be used in alternative embodiments, including for example a salt-water brine solution. In one example, the system may use about 1500 lbs. of the secondary refrigerant.

The secondary refrigerant enters the compressor 142 as a saturated vapor and is compressed to a higher pressure and temperature. The hot vapor from the compressor 142 is routed through the primary refrigerant load subassembly 116, where it is cooled and condensed into a liquid by flowing through a coil immersed in the primary refrigerant.

Upon leaving the primary refrigerant load subassembly 116, the condensed secondary refrigerant is next pumped by pump 144 through expansion valve 146, where it undergoes an abrupt reduction in pressure, resulting in further cooling of the secondary refrigerant. The cold secondary refrigerant is then routed through the refrigeration coil 130 in the retort 110. The heat exchange between the secondary refrigerant in coil 130 and the water vapor in the retort results in condensation of the water vapor in the retort to liquid. This liquid may be collected in a drip pan 152, where it may then be siphoned out of the retort to a tank 154 or simply discarded.

The exchange of heat in the refrigeration coil 130 results in a phase change and heating of the secondary refrigerant. Once through the refrigeration coil 130, the heated secondary refrigerant is again routed to the compressor 142 to complete the cycle.

The primary refrigerant load subassembly 116 may include the same components of the refrigeration cycle described above for circulating the primary refrigerant through subassembly 116 to cool the secondary refrigerant. The primary and secondary refrigeration cycles need not be the same in further embodiments. In one example, the primary refrigerant may be ammonia, though other refrigerants such as Freon, propane and CO₂ may be used as the primary refrigerant.

The present disclosure provides at least two advantages in the use of ammonia over conventional fixed-based coolers using ammonia as the sole refrigerant. First, the ammonia needed to cool the secondary refrigerant is small as compared to that used in fixed-based coolers, and would for example be less than 500 lbs. Such amounts do not require operating or safety permits for its use or transport. Moreover, the ammonia is completely contained within the primary refrigerant load subassembly 116 which, as explained below, may be transported as a single component. Thus, the time, expense and specialized supervision required to pump down ammonia for transport in conventional systems may all be avoided.

The above-described operation, as well as the other operations of the portable cooling unit 100, may be controlled by a control system 170 shown schematically in FIG. 5. The control system may consist of a computing device including processor and memory for running a control algorithm. As described above, the control system 170 controls timing and operation of the drive 136 for translating the shuttle platforms 132, the drive for opening/closing retort doors 122, 124, the evacuation pump 128 to evacuate the retort 110 and the condensation assembly 140. The generator set subassembly 120 may include generator sets for supplying power to the various drive systems described above.

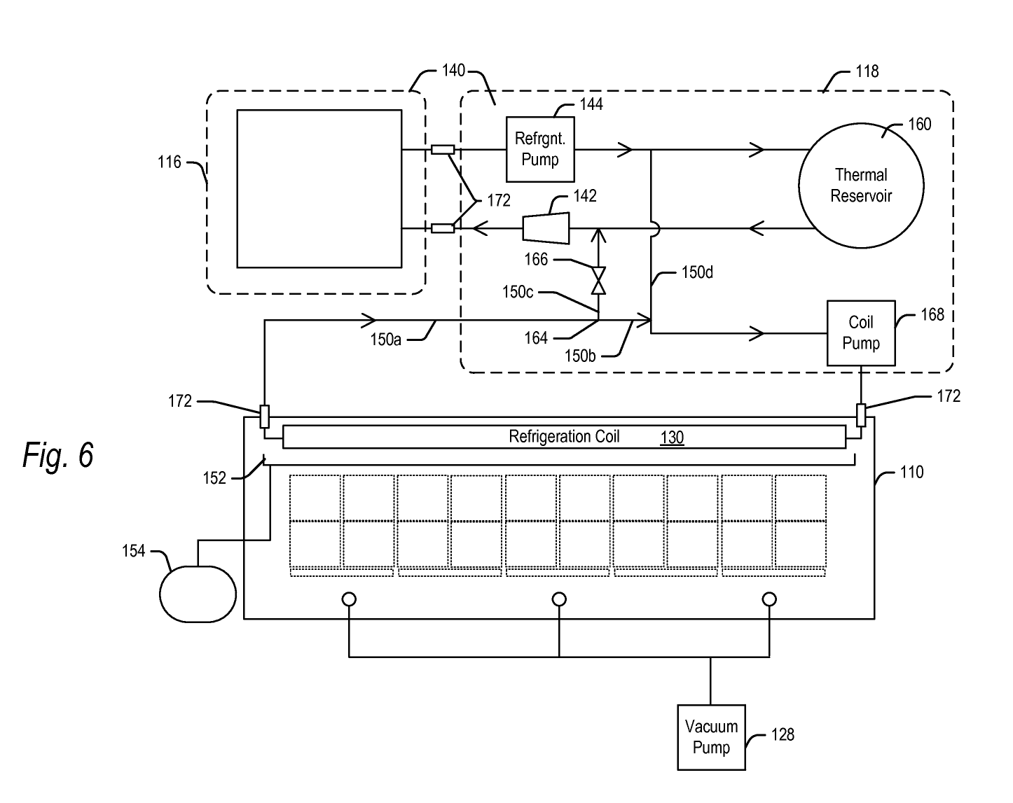

As noted, different embodiments of the present disclosure may use a variety of different refrigeration cycles. FIG. 6 illustrates one such further embodiment. This embodiment takes advantage of the fact that the retort does not need cold refrigerant circulating through the refrigeration coil 130 all of the time. For example, when the doors 122, 124 are open or during evacuation of the retort 110, water is not evaporating from the product, and condensation is not needed. This embodiment stores cold secondary refrigerant during off-peak periods (where there is little or no water evaporation) for use during peak periods (where water is evaporating from the product).

In order to accomplish this, the embodiment of FIG. 6 includes a thermal reservoir 160 receiving cold secondary refrigerant from the primary refrigerant load subassembly 116, and providing secondary refrigerant back to the primary refrigerant load subassembly 116. Additionally, a portion of the line 150 in this embodiment splits at a junction 164, with a first line 150c continuing back to the compressor 142 through a control valve 166, and a second line 150b feeding back into the line 150d supplying cold secondary refrigerant traveling to the refrigeration coil 130.

In this embodiment, hot secondary refrigerant exits the refrigeration coil 130 as described above into line 150a. During off-peak periods, the control valve 166 may be partially closed to shunt the flow of hot refrigerant to line 150b, where it mixes with cold refrigerant from the primary refrigerant load subassembly 116 over line 150d. This mixture from lines 150b and 150d is fed back to the refrigeration coil 130 in the retort 110. A coil pump 168 may be provided in this embodiment to facilitate the pumping of the mixture through the refrigeration coil 130. This mixture is warmer than refrigerant from the primary refrigerant load subassembly by itself (over line 150d), but as this period is off-peak and little or no condensation of water vapor is required, this elevation in temperature is inconsequential.

With the control valve 166 constricting the flow of hot refrigerant back to the subassembly 116, relatively little hot refrigerant circulates back to the subassembly 116 through control valve 166 and compressor 142. The result is that the temperature of the cold refrigerant circulating between the subassembly 116 and thermal reservoir 160 decreases.

Peak periods occur when the retort is evacuated and water evaporates from the product. During peak periods, the control valve 166 may be opened. As a result, hot refrigerant exiting the refrigeration coil 130 over line 150 travels through the line 150c back to the compressor 142 and subassembly 116. In embodiments, a second control valve or a restrictor may be provided in line 150b so that the refrigerant is biased to travel through line 150c and the control valve 166 when the valve is open. Thus, the refrigerant entering the refrigeration coil 130 from line 150d is predominantly or entirely the cold refrigerant from the subassembly 116. As explained above, the temperature of this refrigerant over line 150d has been further reduced as a result of the circulation between the subassembly 116 and reservoir 160 during the off-peak period. This cold refrigerant optimizes condensation of the water vapor by the refrigeration coil 130 during peak periods.

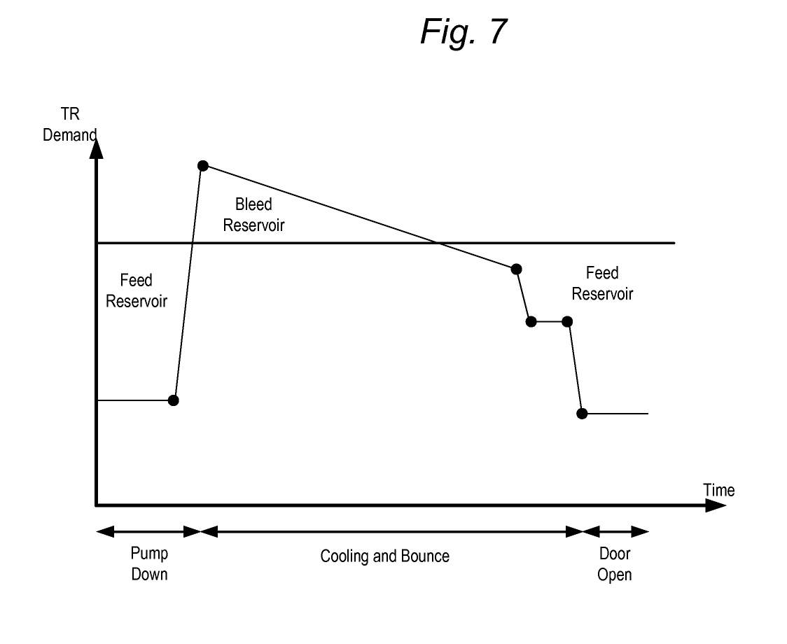

FIG. 7 is a graph of the operation of the embodiment as described above. During the pump down of the retort 110 and when the doors 122, 124 are open, the reservoir 160 is being fed, i.e., the temperature of the refrigerant in the reservoir 160 is decreasing. During the peak period when water evaporation is occurring, the reservoir is being bled, i.e., the temperature of the refrigerant in the reservoir 160 is increasing. The control system 170 operates the control valve 166 to cycle between open and closed in sync with the peak and off-peak periods shown on the graph of FIG. 7 to deliver the coldest refrigerant to the refrigeration coil 130 when it is needed the most, thus increasing the condensation efficiency of the condensation assembly 140.

As noted above, it is a drawback to conventional fixed-base cooling units that break down and transport of such units is difficult, time-consuming and hindered by administrative regulations. The portable cooling unit 100 of the present disclosure overcomes these drawbacks. The cooling unit 100 is constructed of modular subassemblies which are easily disconnected from each other and each may then be easily transported. For example, as shown in FIG. 4, the shuttles 112, 114 may be easily separated from the retort 110 by lifting the pins 138 on the end of each shuttle out of their respective sockets. As noted above, the carriages 134 of shuttles 112, 114 may include hydraulic suspensions for raising and lowering the shuttles. Once separated from the retort 110, the shuttles may then be lifted onto a flatbed, stored on top of the retort, or connected directly to the cab of a semitrailer (where the shuttles have an axle and wheels) and transported.

Once the refrigerant lines 150 and power lines are disconnected from the retort 110 as described below, the retort 110 may similarly be easily transported by itself, or together with the shuttles 112, 114. The retort may be lifted onto the flatbed of a trailer, or the retort may include an undercarriage with an axle and wheels so that it may be connected to a semitrailer cab and driven away.

Additionally, the primary refrigerant load subassembly 116, the secondary refrigerant load subassembly 118 and the generator set subassembly 120 may each be quickly and easily disconnected from each other and the retort 110. The lines 150 may include hose couplings 172 which connect the lines running between the primary and secondary refrigerant load subassemblies, and between the secondary refrigerant load subassembly and the retort 110. These couplings may be easily connected and disconnected to separate the respective subassemblies from each other and the retort 110. Power lines from the generator set subassembly 120 may similarly be quickly connected and disconnected.

Moreover, all of the ammonia used by the portable cooling unit 100 is completely contained within the primary refrigerant load subassembly 116. Thus, when disassembling the cooling unit 100, there is no need to pump ammonia out of the lines 150 running to the retort 110. The ammonia remains within the primary refrigerant load subassembly 116. Once the lines 150 from the secondary refrigerant load subassembly 118 are decoupled, the primary refrigerant load subassembly 116 may be easily transported on its own, for example by lifting it onto a flatbed, or mounting it on an undercarriage having an axle and wheels so that it may be hooked to a semitrailer cab and driven away.

Furthermore, the system uses only a small amount of ammonia (less than 500 lbs.). Thus, no operating or safety permits are required by the Environmental Protection Agency, Department of Transportation or other regulatory body for the use or transport of the ammonia. Similarly, special authorized technicians are not required when breaking down the portable cooling unit 100 for transport.

As the use of glycol as the secondary refrigerant does not require permits or oversight, the glycol may be easily and inexpensively pumped down from the lines 150 upon disassembly. The lines 150 may then be disconnected at the couplings 172, and the secondary refrigerant load subassembly may be transported as a single unit. The secondary refrigerant load subassembly 118 may be transported for example by lifting it onto a flatbed, or mounting it on an undercarriage having an axle and wheels so that it may be hooked to a semitrailer cab and driven away. The generator set subassembly 120 may disconnected, and transported as a single unit in the same way.

The modularity of the various subassemblies and the selection of refrigerants not requiring operating and safety permits all contribute to a portability of the cooling system 100 not seen in conventional systems. This portability allows a cooling unit 100 to be transported in modular subassemblies to a worksite such as a field where produce is harvested, and quickly assembled into a working unit. After harvesting at that field is completed, the cooling unit 100 may be quickly disassembled into the modular subassemblies and transported to the next harvest or other worksite. In embodiments, when connected to a semitrailer, each of the above-described modular subassemblies may be over-the-road legal under the Department of Transportation (DOT) and Federal Motor Vehicle Safety Standards (FMVSS), for example possibly requiring only an oversized permit.

In summary, the present technology relates to a portable vacuum cooling unit for initiating a cold chain for produce at a site where the produce is harvested, comprising: a retort; at least one shuttle; and a condensation assembly configured to perform a refrigeration cycle, the retort, at least one shuttle and condensation assembly operating at the site where produce is harvested to vacuum cool the produce after harvesting.

In a further example, the present technology relates to a portable vacuum cooling unit for initiating a cold chain for produce at a site where the produce is harvested, comprising: a retort; at least one shuttle; a primary refrigerant load configured to perform a first refrigeration cycle; and a secondary refrigerant load configured to perform a second refrigeration cycle, the retort, at least one shuttle, primary refrigerant load and secondary refrigerant load configured to vacuum cool produce at the site where the produce is harvested when assembled together, and each of the retort, at least one shuttle, primary refrigerant load and secondary refrigerant load disassembling for transport as modular components.

In another example, the present technology relates to a portable vacuum cooling unit for initiating a cold chain for product at a worksite, comprising: a retort; at least one shuttle; a primary refrigerant load configured to perform a first refrigeration cycle using ammonia as a primary refrigerant; and a secondary refrigerant load configured to perform a second refrigeration cycle using a secondary refrigerant, the retort, at least one shuttle, primary refrigerant load and secondary refrigerant load configured to cool product by vacuum cooling the product when assembled together, each of the retort, at least one shuttle, primary refrigerant load and secondary refrigerant load disassembling for transport as modular components, and wherein the ammonia remains contained completely within the primary refrigerant load during vacuum cooling of the product and transport of the primary refrigerant load.

In a further example, the present technology relates to a portable vacuum cooling unit for initiating a cold chain for product at a worksite, comprising: a retort including a vacuum pump for evacuating the retort; at least one shuttle; a primary refrigerant load configured to perform a first refrigeration cycle; and a secondary refrigerant load configured to perform a second refrigeration cycle using a secondary refrigerant, the secondary refrigeration cycle condensing water vapor within the retort upon evacuation of the retort by the vacuum pump, and the primary refrigeration cycle cooling the secondary refrigerant for the secondary refrigeration cycle.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

We claim:

1. A portable vacuum cooling unit for initiating a cold chain for produce at a site where the produce is harvested, comprising:
a retort;
at least one shuttle; and
a condensation assembly configured to perform a refrigeration cycle,
the retort, at least one shuttle and condensation assembly operating at the site where produce is harvested to vacuum cool the produce after harvesting.

2. The portable vacuum cooling unit recited in claim 1, wherein the condensation assembly includes a primary refrigerant load and a secondary refrigerant load, the primary refrigerant load configured to cool a secondary refrigerant of the secondary refrigerant load, the secondary refrigerant configured to condense water vapor evaporated from the produce during the vacuum cooling process.

3. The portable vacuum cooling unit recited in claim 1, wherein the primary refrigeration load uses a primary refrigerant including one of ammonia, Freon, propane and CO₂ to cool the secondary refrigerant.

4. The portable vacuum cooling unit recited in claim 4, wherein the secondary refrigerant includes one of glycol and a salt-water brine solution.

5. The portable vacuum cooling unit recited in claim 1, wherein the cooling unit does not require operating, safety or hazardous materials permits for lawful operation.

6. The portable vacuum cooling unit recited in claim 1, wherein the refrigeration portion of the cooling unit does not require permits for lawful transportation.

7. The portable vacuum cooling unit recited in claim 1, wherein the cooling unit does not require operating permits, safety permits or sight by an authorized refrigeration technician for lawful disassembly of the cooling unit.

8. The portable vacuum cooling unit recited in claim 1, wherein the retort, at least one shuttle and condensation assembly vacuum cool leafy vegetables.

9. The portable vacuum cooling unit recited in claim 1, wherein the retort, at least one shuttle and condensation assembly vacuum cool lettuce.

10. A portable vacuum cooling unit for initiating a cold chain for produce at a site where the produce is harvested, comprising:
a retort;
at least one shuttle;
a primary refrigerant load configured to perform a first refrigeration cycle; and
a secondary refrigerant load configured to perform a second refrigeration cycle,
the retort, at least one shuttle, primary refrigerant load and secondary refrigerant load configured to vacuum cool produce at the site where the produce is harvested when assembled together, and each of the retort, at least one shuttle, primary refrigerant load and secondary refrigerant load disassembling for transport as modular components.

11. The portable vacuum cooling unit of claim 10, wherein the primary refrigerant load includes a primary refrigerant and the secondary refrigerant load includes a secondary refrigerant, the primary refrigerant cooling the secondary refrigerant, and the secondary refrigerant condensing water vapor in the retort during vacuum cooling of the produce.

12. The portable vacuum cooling unit of claim 11, wherein the primary refrigerant remains completely contained within the primary refrigerant load during vacuum cooling of the produce and transport.

13. The portable vacuum cooling unit of claim 11, wherein the at least one shuttle comprises a pair of shuttles removably mounted at opposite ends of the retort during vacuum cooling of the produce.

14. The portable vacuum cooling unit of claim 13, wherein each shuttle includes a pin received within respective sockets on the retort to removably mount the shuttles to the retort.

15. The portable vacuum cooling unit of claim 10, further comprising a generator set for supplying power to the retort, primary refrigerant load and secondary refrigerant load, the generator set dissembling into a modular component for transport.

16. The portable vacuum cooling unit of claim 10, further comprising a thermal reservoir for banking cold secondary refrigerant during off-peak periods where produce is not vacuum cooled, the banked cold secondary refrigerant used during peak periods where the produce is vacuum cooled.

17. A portable vacuum cooling unit for initiating a cold chain for product at a worksite, comprising:
a retort;
at least one shuttle;
a primary refrigerant load configured to perform a first refrigeration cycle; and
a secondary refrigerant load configured to perform a second refrigeration cycle using a secondary refrigerant,
the retort, at least one shuttle, primary refrigerant load and secondary refrigerant load configured to cool product by vacuum cooling the product when assembled together, each of the retort, at least one shuttle, primary refrigerant load and secondary refrigerant load disassembling for transport as modular components, and
wherein the primary refrigerant remains contained completely within the primary refrigerant load during vacuum cooling of the product and transport of the primary refrigerant load.

18. The portable vacuum cooling unit of claim 17, wherein the product is produce and the worksite where the produce is cooled is a site where the produce is harvested.

19. The portable vacuum cooling unit of claim 17, wherein the secondary refrigerant is one of glycol and a salt-water brine.

20. The portable vacuum cooling unit of claim 17, wherein each of the modular components are DOT and FMVSS legal for travel over a highway.

21. The portable vacuum cooling unit of claim 17, wherein each of the primary refrigerant is one of ammonia, Freon, propane and CO₂.

22. A portable vacuum cooling unit for initiating a cold chain for product at a worksite, comprising:
a retort including a vacuum pump for evacuating the retort;
at least one shuttle;
a primary refrigerant load configured to perform a first refrigeration cycle; and
a secondary refrigerant load configured to perform a second refrigeration cycle using a secondary refrigerant,
the secondary refrigeration cycle condensing water vapor within the retort upon evacuation of the retort by the vacuum pump, and
the primary refrigeration cycle cooling the secondary refrigerant for the secondary refrigeration cycle.

23. The portable vacuum cooling unit of claim 22, wherein the primary refrigerant remains contained completely within the primary refrigerant load during vacuum cooling of the product and transport of the primary refrigerant load.

24. The portable vacuum cooling unit of claim 22, wherein the retort, at least one shuttle, primary refrigerant load and secondary refrigerant load are configured to cool product by vacuum cooling the product when assembled together, each of the retort, at least one shuttle, primary refrigerant load and secondary refrigerant load disassembling for transport as modular components, and

25. The portable vacuum cooling unit of claim 24, wherein each of the modular components are DOT and FMVSS legal for travel over a highway.

26. The portable vacuum cooling unit of claim 22, wherein the product is produce and the worksite where the produce is cooled is a site where the produce is harvested.

27. The portable vacuum cooling unit of claim 22, wherein the secondary refrigerant is one of glycol and a salt-water brine.

28. The portable vacuum cooling unit of claim 22, wherein each of the primary refrigerant is one of ammonia, Freon, propane and CO₂.
